(19) United States
(12) Patent Application Publication
(10) Pub. No.: US 2022/0171564 A1
(43) Pub. Date: Jun. 2, 2022

(54) APPARATUS AND METHOD FOR MAINTAINING DATA STORED IN A MEMORY SYSTEM

(71) Applicant: SK hynix Inc., Gyeonggi-do (KR)

(72) Inventors: Jun Hee RYU, San Jose, CA (US); Hyung Jin LIM, San Jose, CA (US); Myeong Joon KANG, San Jose, CA (US); Kwang Jin KO, San Jose, CA (US); Woo Suk CHUNG, San Jose, CA (US); Yong JIN, San Jose, CA (US)

(21) Appl. No.: 17/108,568

(22) Filed: Dec. 1, 2020

(51) Int. Cl. G06F 3/06

(52) U.S. Cl. CPC G06F 3/0655; G06F 3/0679; G06F 3/0619

(57) ABSTRACT

A memory system includes a memory device including a first memory block and a second memory block, wherein the first memory block stores a first data chunk having a first size and the second memory block stores a second data chunk having a second size, and the first size is less than the second size; and a controller operatively coupled to the memory device, wherein the controller is configured to read the second data chunk from the second memory block, correct at least one error of the second data chunk when the at least one error is detected, and copy a portion of the second data chunk to the first memory block, wherein the portion of the second data chunk is error-corrected and has the first size.

### TECHNICAL FIELD

The disclosure relates to a memory system, and more particularly, to an apparatus and a method for maintaining data stored in the memory system.

### BACKGROUND

Recently, a paradigm for a computing environment has shifted to ubiquitous computing, which enables computer systems to be accessed virtually anytime, anywhere. As a result, the use of portable electronic devices, such as mobile phones, digital cameras, notebook computers, and the like, are rapidly increasing. Such portable electronic devices typically use or include a memory system that uses or embeds at least one memory device, i.e., a data storage device. The data storage device can be used as a main storage device or an auxiliary storage device of a portable electronic device.

Unlike a hard disk, a data storage device using a non-volatile semiconductor memory device is advantageous in that it has excellent stability and durability because it has no mechanical driving part (e.g., a mechanical arm), and has high data access speed and low power consumption. In the context of a memory system having such advantages, an exemplary data storage device includes a USB (Universal Serial Bus) memory device, a memory card having various interfaces, a solid state drive (SSD), or the like.

### BRIEF DESCRIPTION OF THE DRAWINGS

The description herein makes reference to the accompanying drawings wherein like reference numerals refer to like parts throughout the figures.

FIG. 1 illustrates a memory system according to an embodiment of the disclosure.

FIG. 2 illustrates a data processing system according to an embodiment of the disclosure.

FIG. 3 illustrates a memory system according to an embodiment of the disclosure.

FIG. 4 illustrates a data chunk and a map data segment stored in a memory device according to an embodiment of the disclosure.

FIG. 5 describes a first example of a method for operating a memory system according to an embodiment of the disclosure.

FIG. 6 illustrates a procedure for maintaining, protecting, or copying a data chunk stored in a memory device based on a data retention time.

FIG. 7 illustrates a second example of a method for operating a memory system according to an embodiment of the disclosure.

FIG. 8 describes a data retention time and endurance of the memory device.

FIG. 9 illustrates a third example of a method for operating a memory system according to an embodiment of the disclosure.

FIG. 10 illustrates an example of how to determine a level of error in a data chunk accessed through a read operation.

FIG. 11 illustrates an example of an operation for refreshing non-volatile memory cells in a memory device.

### DETAILED DESCRIPTION

Various embodiments of the disclosure are described below with reference to the accompanying drawings. Elements and features of the disclosure, however, may be configured or arranged differently to form other embodiments, which may be variations of any of the disclosed embodiments.

In this disclosure, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

In this disclosure, the terms “comprise,” “comprising,” “include,” and “including” are open-ended. As used herein, these terms specify the presence of the stated elements/components and do not preclude the presence or addition of one or more other elements/components.

In this disclosure, various units, circuits, or other components may be described or claimed as “configured to” perform a task or tasks. In such context, “configured to” is used to connote structure by indicating that the blocks/units/circuits/components include structure (e.g., circuitry) that performs one or more tasks during operation, As such, the unit/circuit/component can be said to be configured to perform the task even when the specified blocks/unit/circuit/component is not currently operational (e.g., is not on). The blocks/units/circuits/components used with the “configured to” language include hardware-for example, circuits, memory storing program instructions executable to implement the operation, etc. Reciting that a block/unit/circuit/component is “configured to” perform one or more tasks is expressly intended not to invoke 35 U.S.C. § 112(f) for that block/unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

As used in the disclosure, the term ‘circuitry’ refers to any and all of the following: (a) hardware-only circuit implementations (such as implementations in only analog and/or digital circuitry) and (b) combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” also covers an implementation of merely a processor (or multiple processors) or portion of a processor and its (or their) accompanying software and/or firmware. The term “circuitry” also covers, for example, and if applicable to a particular claim element, an integrated circuit for a storage device.

As used herein, these terms “first,” “second,” “third,” and so on are used as labels for nouns that they precede, and do not imply any type of ordering (e.g., spatial, temporal, logical, etc.). The terms “first” and “second” do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term “based on” is used to describe one or more factors that affect a determination. This term does not foreclose additional factors that may affect a determination. That is, a determination may be solely based on those factors or based, at least in part, on those factors, Consider the phrase “determine A based on B.” While in this case, B is a factor that affects the determination of A, such a phrase does not foreclose the determination of A from also being based on C. In other instances, A may be determined based solely on B.

An embodiment of the disclosure can provide a data process system and a method for operating the data processing system, which includes components and resources such as a memory system and a host and is capable of dynamically allocating plural data paths used for data communication between the components based on usages of the components and the resources.

An embodiment of the disclosure can provide an apparatus and/or a method for maintaining, protecting, or preserving data stored in a non-volatile memory device, based on a retention time, to improve operational reliability of a memory system. When data has been programmed in a specific location within the non-volatile memory device for a long time, the memory system may re-program the data to another location within the non-volatile memory device for data protection, i.e., avoiding retention loss.

When voluminous data stored in the non-volatile memory device should be often re-programmed in another location, this re-program operation may affect endurance, i.e., a Program/Erase (P/E) cycle regarding a memory block, of the non-volatile memory device. The memory system may employ plural types of mapping information (e.g., first mapping information and second mapping information) which are used for address translation to access the data stored in the non-volatile memory device. When a size of data associated with first mapping information is different from that of data associated with second mapping information, the memory system may re-program some, not all, of data, which has possibility of retention loss, to another location within the non-volatile memory device. For example, an apparatus and a method for maintaining, preserving, or protecting data in the memory system may determine or select at least one first data chunk among second data chunks corresponding to second map data, according to an error level or an error possibility, and copy the at least one first data chunk to a cache memory block. Compared with a method for copying all data chunks to the cache memory block for data protection, the apparatus and the method can reduce the consumption of resources in the memory system to secure data safety. Herein, a chunk of data or a data chunk may be a sequence of bits. For example, the data chunk may include the contents of a file, a portion of the file, a page in memory, an object in an object-oriented program, a digital message, a digital scanned image, a part of a video or audio signal, or any other entity which can be represented by a sequence of bits. According to an embodiment, the data chunk may include a discrete object. According to another embodiment, the data chunk may include a unit of information within a transmission packet between two different components.

In an embodiment, a memory system can include a memory device including a first memory block and a second memory block, wherein the first memory block stores a first data chunk having a first size and the second memory block stores a second data chunk having a second size, and the first size is less than the second size; and a controller operatively coupled to the memory device, wherein the controller is configured to read the second data chunk from the second memory block, correct at least one error of the second data chunk when the at least one error is detected, and copy a portion of the second data chunk to the first memory block, wherein the portion of the second data chunk is error-corrected and has the first size.

The memory device can be further configured to store a first map data segment associated with the first data chunk and a second map data segment associated with the second data chunk. The controller can be further configured to check an operational status of the second memory block to determine whether to read the second data chunk from the second memory block, and the controller is configured to read the second data chunk from the second memory block based on the second map data segment.

The operational status of the second memory block can be determined based on a retention time and a program erase cycle (P/E cycle) of the second memory block.

A number of bits stored in a non-volatile memory cell included in the first memory block can be less than a number of bits stored in a non-volatile memory cell in the second memory block.

The first memory block can be used as a cache memory and the second memory block is used as a main storage. The controller can be further configured to perform a read operation on the first memory block first before accessing the second memory block.

The controller can be configured to determine an error level of the second data chunk based on at least one of an amount of errors detected or a process for correcting the error detected in the second data chunk, and copy the error-corrected portion of the second data chunk to first memory block when the error level of the second data chunk is greater than or equal to a threshold.

The controller is configured to refresh the second memory block when the error level is less than the threshold.

The controller can be further configured to determine the threshold based on at least one of an operational status of the second memory block, an error correction capability of the controller and a performance of the memory system.

The controller can be further configured to determine whether to read the second data chunk after entering an idle state.

The first map data segment can be stored in the first memory block and the second map data segment can be stored in the second memory block.

The first map data segment and the second map data segment can be stored in a third memory block which is different from either of the first and second memory blocks.

In another embodiment, a method for operating a memory system can include reading a second data chunk from a second memory block; correcting at least one error of the second data chunk when the at least one error is detected; and copying a portion of the second data chunk to a first memory block. The first memory block can store the first data chunk having a first size and the second memory block can store the second data chunk having a second size. The first size can be less than the second size. The portion of the second data chunk can be error-corrected and have the first size.

The method can further include storing a first map data segment associated with the first data chunk and a second map data segment associated with the second data chunk; and checking an operational status of the second memory block to determine whether to read the second data chunk stored in the second memory block. The second data chunk can be read from the second memory block based on the second map data segment.

The operational status of the second memory block can be determined based on a retention time and a program/erase cycle (P/E cycle) of the second memory block.

A number of bits stored in a non-volatile memory cell included in the first memory block can be less than a number of bits stored in a non-volatile memory cell included in the second memory block.

The method can further include performing a read operation on the first memory block first before accessing the second memory block, wherein the first memory block is used as a cache memory and the second memory block is used as a main storage.

The method can further include determining an error level of the second data chunk based on an amount of errors detected or a process for correcting the error detected in the second data chunk. The copying the error-corrected portion of the second data chunk includes copying the part of the second data chunk to first memory block when the error level of the second data chunk is greater than or equal to a threshold.

The copying of the portion of the second data chunk can further include refreshing the second memory block when the error level is less than the threshold.

The method can further include determining the threshold based on at least one of an operational status of the second memory block, an error correction capability of the controller and a performance of the memory system.

The method can further include determining whether to read the second data chunk after entering an idle state.

The method can further include storing the first map data segment in the first memory block and the second map data segment in the second memory block individually.

The method can further include storing the first map data segment and the second map data segment in a third memory block which is different from either of the first and second memory blocks.

In another embodiment, a computer program product tangibly can be stored on a non-transitory computer readable medium. The computer program product can include instructions to cause a multicore processor device that comprises a plurality of processor cores, each processor core comprising a processor and circuitry configured to couple the processor to a memory device including a first memory block storing a first data chunk having a first size and a second memory block is storing a second data chunk having a second size, to: read the second data chunk from the second memory block; correct at least one error of the second data chunk when the at least one error is detected; and copy a portion of the second data chunk to the first memory block. The portion of the second data chunk can be error-corrected and have the first size. The first size can be less than the second size.

The computer program product can further include instruction to cause the multicore process to check an operation& status of the second memory block to determine whether to read the second data chunk in the second memory block, and copy the error-corrected portion of the second data chunk or refreshing the second data chunk based on an error level of the second data chunk based on an amount of errors detected in the second data chunk or a process for correcting the error detected in the second data chunk.

In another embodiment, an operating method of a controller for controlling a memory device including first and second memory blocks can include: controlling the memory device to read, on a second data size basis, plural pieces of data from the second memory block; error-correcting one or more of the read pieces; and controlling the memory device to store, on a first data size basis, the error-corrected pieces into the first memory block, wherein the first memory block is configured by lower storage capacity memory cells than the second memory block, and wherein the first data size basis is less than the second data size basis.

Embodiments of the disclosure are described below with reference to the accompanying drawings, wherein like numbers reference refers to like elements.

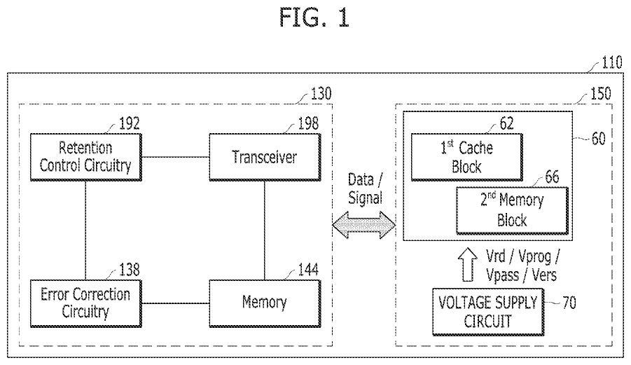

FIG. 1 illustrates a memory system according to an embodiment of the disclosure,

Referring to FIG. 1, a memory system 110 may include a memory device 150 and a controller 130. The memory device 150 and the controller 130 in the memory system 110 may be physically separate elements. In that case, the memory device 150 and the controller 130 may be connected via at least one data path, which may include a channel and/or a way.

In another embodiment, the memory device 150 and the controller 130 may be physically integrated but functionally divided. Further, according to an embodiment, the memory device 150 and the controller 130 may be implemented with a single chip or a plurality of chips.

The memory device 150 may include a plurality of memory blocks 60, two of which 62, 66 are shown. Each of the memory blocks 60 may include a group of non-volatile memory cells in which data is removed together by a single erase operation. Although not illustrated, each memory block may include a page which is a group of non-volatile memory cells that store data together during a single program operation or output data together during a single read operation. Each memory block may include a plurality of pages.

According to an embodiment, among the plurality of memory blocks 60, memory block 62 may be a first cache memory block. For example, the first cache memory block 62 including a plurality of non-volatile memory cells can be used to support a fast data input/output operation, and/or reduce or alleviate a bottleneck caused by a difference in operation speeds between components in the memory system 110. Second memory block 66 may be used to store data input from an external source. To provide the memory device 150 with increased storage capacity to accommodate user's needs, the second memory block 66 may include non-volatile memory cells capable of storing mufti-bit data. For example, the first cache memory block 62 works as a cache memory which temporarily stores data while the second memory block 66 is used as a main storage.

According to an embodiment, the first cache memory block 62 can operate to store or output data at a higher speed than can the second memory block 66. In addition, data may be stored in, or deleted from, the first cache memory block 62 more times than data is stored in, or deleted from, the second memory block 66. Accordingly, the non-volatile memory cells included in the first cache memory block 62 may store a smaller amount of data (e.g., data having a smaller number of bits) than the non-volatile memory cells included in the second memory block 66. Further, a size of data input or output through a single program operation or a single read operation may be different. Compared with the first cache memory block 62, the size of data input/output from/to the second memory block 66 may be greater.

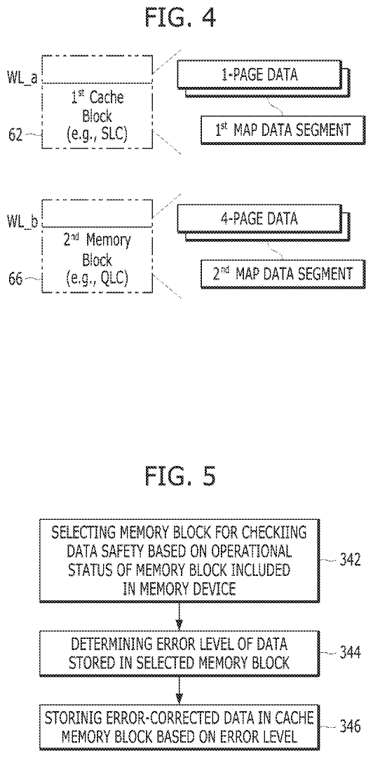

Each of the plurality of memory blocks 60 may include a user data chunk, which is transmitted from an external device and stored in the memory device 150, and a meta data chunk associated with the user data chunk for an internal operation. For example, the meta data chunk may include mapping information as well as information related to the operational status of the memory device 150. Here, the mapping information includes data mapping a logical address used by an external device to a physical address used in the memory device 150, To store more user data chunks in each of the plurality of memory blocks 60, the memory system 110 may reduce a size of the meta data chunk. Further, a size of a user data chunk corresponding to mapping information stored in the first cache memory block 62 may be different from that corresponding to mapping information stored in the second memory block 66. For example, the size of a user data chunk associated with the mapping information of the first cache memory block 62 may be less than the size of a user data chunk corresponding to the mapping information of the second memory block 66. The size of user data chunk associated with the mapping information is described below with reference to FIG. 4.

Although not shown in FIG. 1, the memory device 150 may include a plurality of memory planes or a plurality of memory dies. According to an embodiment, a memory plane may be considered a logical or a physical partition including at least one memory block 60, a driving circuit capable of controlling an array including a plurality of non-volatile memory cells, and a buffer that can temporarily store data inputted to, or outputted from, non-volatile memory cells.

In addition, according to an embodiment, a memory die may include at least one memory plane. The memory die may be understood as a set of components implemented on a physically distinguishable substrate. Each memory die may be connected to the controller 130 through a data path. Each memory die may include an interface to exchange a piece of data and a signal with the controller 130.

According to an embodiment, the memory device 150 may include at least one memory block 60, at least one memory plane, or at least one memory die. The internal configuration of the memory device 150 shown in FIG. 1 may be different according to performance of the memory system 110. Thus, the present invention is not limited to the internal configuration shown in FIG. 1.

Referring to FIG. 1, the memory device 150 may include a voltage supply circuit 70 capable of supplying at least one voltage to the memory blocks 62, 66. The voltage supply circuit 70 may supply a read voltage Vrd, a program voltage Vprog, a pass voltage Vpass, or an erase voltage Vers to a non-volatile memory cell in the memory block 60. For example, during a read operation for reading data stored in a selected non-volatile memory cell in the memory block 60, the voltage supply circuit 70 may supply the read voltage Vrd to the selected non-volatile memory cell. During the program operation for is storing data in a non-volatile memory cell included in the memory blocks 62, 66, the voltage supply circuit 70 may supply the program voltage Vprog to a selected non-volatile memory cell. Also, during a read operation or a program operation performed on the selected nonvolatile memory cell, the voltage supply circuit 70 may supply a pass voltage Vpass to a non-selected nonvolatile memory cell. During the erasing operation for erasing data stored in the non-volatile memory cell in the memory block 62, 66, the voltage supply circuit 70 may supply the erase voltage Vers into the memory block 60.

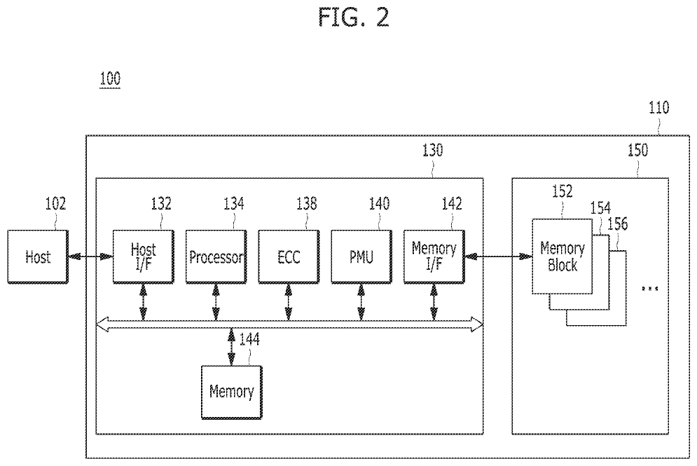

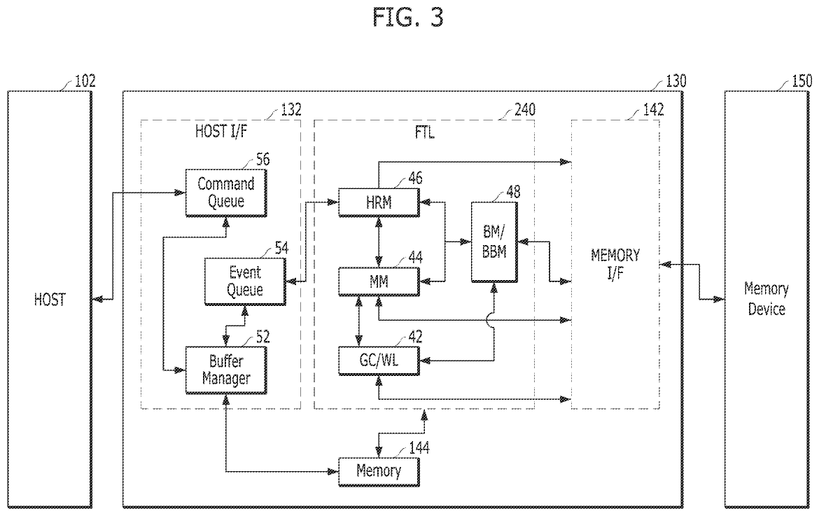

In order to store data in response to a request by an external device (e.g., host 102, see FIGS. 2-3) in a storage space including non-volatile memory cells, the memory system 110 may perform address translation associating a file system used by the host 102 with the storage space including the non-volatile memory cells. For example, an address indicating data according to the file system used by the host 102 may be called a logical address or a logical block address, while an address indicating data stored in the storage space including the non-volatile memory cells may be called a physical address or a physical block address. When the host 102 transmits a logical address with a read request to the memory system 110, the memory system 110 searches for a physical address corresponding to the logical address and then transmits data stored in a location indicated by the physical address to the host 102. During these processes, the address translation may be performed by the memory system 110 to search for the physical address corresponding to the logical address input from the host 102.

In response to a request input from the external device, the controller 130 may perform a data input/output operation. For example, when the controller 130 performs a read operation in response to a read request input from an external device, data stored in a plurality of non-volatile memory cells in the memory device 150 is outputted to the controller 130. For a read operation, the controller 130 may perform address translation regarding a logical address input from the external device, and then transmit the read request to the memory device 150 corresponding to a physical address, obtained though the address translation, via the transceiver 198. The transceiver 198 may transmit the read request to the memory device 150 and receive data output from the memory device 150. The transceiver 198 may store data output from the memory device 150 in the memory 144. The controller 130 may output data stored in the memory 144 to the external device as a result corresponding to the read request.

In addition, the controller 130 may transmit data input along with a write request from the external device to the memory device 150 through the transceiver 198. After the data is stored in the memory device 150, the controller 130 may transmit a response or an answer to the write request to the external device. The controller 130 may update map data that associates a physical address, which identifies a location where the data is stored in the memory device 150, with a logical address input along with the write request.

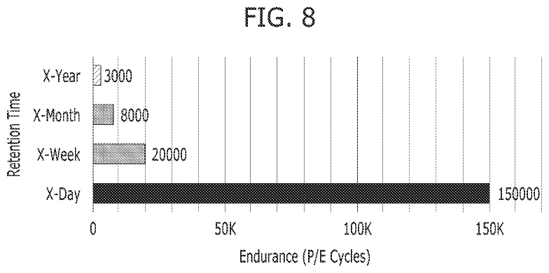

A retention time in which data is stored in a non-volatile memory cell in the memory device 150 is limited. As performance of the memory device 150 related to storage capacity or input/output speed is improved or a size of a non-volatile memory cell decreases, data retention time may decrease. The retention time of data may be also varied based on an internal temperature and endurance of the memory device 150. In addition, retention time of specific data may vary depending on a location in which the data is stored in the memory device 150, a value of the data, and the like. This is because it is very difficult to completely confine electrons corresponding to the data in a floating gate of a non-volatile memory cell. A retention time of data is described below with reference to FIG. 8.

The controller 130 may estimate a retention time for data stored in the memory device 150 for operational reliability and data safety. Also, the controller 130 may monitor or check endurance of non-volatile memory cells in the memory device 150. Depending on an embodiment, the controller 130 may determine, track, control or manage retention time and durability on a block-by-block basis.

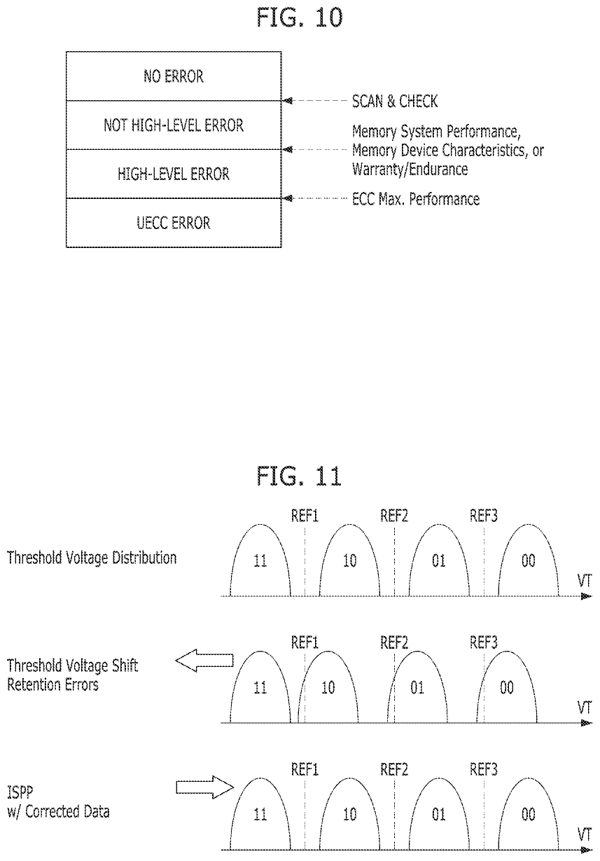

Retention control circuitry 192 included in the controller 130 may collect operation information of the memory device 150 and determine or check safety of data stored in the memory device 150. For example, the retention control circuitry 192 may collect operation information (retention time, P/E cycle, etc.) regarding the plurality of memory blocks 60 in the memory device 150. The retention control circuitry 192 may select a memory block, among the plurality of memory blocks 60, based on the operation information. Thus, the memory block in which data safety is suspect or in question can be selected. The retention control circuitry 192 can scan or read at least a portion of data from the selected memory block through the transceiver 198 and store that data, read from the memory block, in the memory 144. Regarding data read by the retention control circuitry 192, error correction circuitry 138 may check whether there is an error in the data stored in the memory 144. When the error correction circuitry 138 determines that there is no error in read data, the retention control circuitry 138 may read another portion of the data stored in the selected memory block. When an error is detected in the read data, the error correction circuitry 138 may correct the error and recover the data. When the error correction circuitry 138 indicates an error level determined based on an error detected in the data, the retention control circuitry 192 may determine whether to copy the recovered data to another memory block or to leave the data where it is. According to an embodiment, the retention control circuitry 192 can refresh the data stored in its original location. That is, the retention control circuitry 138 may determine a method for maintaining and managing the data based on a level of error detected in the data. The level of error in the data is described below with reference to FIG. 10.

According to an embodiment, when the retention control circuitry 192 reads a data chunk stored in a selected memory block, a size of a data chunk that the controller 130 can read at one time (e.g., as a unit) may be determined according to a map data segment associated with the data chunk stored in the memory block. For example, a size of a data chunk, which the controller 130 can read at one time, from the second memory block 66 according to a map data segment is greater than a size of a data chunk, which the controller 130 can read at one time, from the first cache memory block 62. Even though a first user data chunk and a second user data chunk may be read or programmed on a page-by-page basis from the first cache memory block 62 and the second memory block 66, respectively, a single second map data segment (L2P segment) can correspond to, or be associated with, plural data chunks stored in plural pages of the second memory block 66. An error can be detected in a portion, but not all, of the data chunks, which the controller 130 reads at one time, from the second memory block 66. For example, the error occurs in at least one data chunk among the data chunks. If the entire data chunks read are copied to another location in the memory device 150 even when the error is detected in a portion, but not all, of the data chunks, such operation may significantly increase resource consumption of the memory device 150 to secure data protection or data safety. Further, an operation of copying a large amount of data to another location of the memory device 150 may require a wide (or long) margin for a read or program operation (e.g., operation-timing margin), which is generally proportional to the size of the data chunks, which increases overhead in the memory system 110, regardless of a data input/output operation requested from the external device.

However, in an embodiment, the retention control circuitry 192 may copy only some, not overall, portion in which an error is detected within the read data to the first cache memory block 62. For example, even though a size of read data, which the controller 130 can read at a time from the second memory block 66 is 8 MB or 216 MB, but an error is detected from a data chunk of 8 KB or 16 KB within the read data of 8 MB or 216 MB, the retention control circuitry 192 can copy only the data chunk having the 8 KB or 16 KB size to the first cache memory block 62 after the error detected in the data chunk of the 8 KB or 16 KB is corrected. The size of data chunk copied to the first cache memory block 62 by the retention control circuitry 192 may be determined according to a map data segment associated with the data chunk stored in the first cache memory block 62. For data safety or data protection, the retention control circuitry 192 does not have to copy all the 8 MB or 216 MB read data, which the controller 130 reads at a time, from the second memory block 66 to another memory block (such as the first cache memory block 62). But, the retention control circuitry 192 copies only 8 KB or 16 KB data chunk within the 8 MB or 216 MB read data to the first cache memory block 62. In a case when only some, not all, data chunk is copied into the first cache memory block 62, it is possible to reduce a program operation regarding some portion of data which has no error, thereby reducing overhead of the memory system 110 and reducing durability deterioration of the memory device 150 (i.e., avoiding increase of P/E cycles in the memory device 150).

According to an embodiment, a map data segment associated with a data chunk stored in a memory block may be stored in the same memory block in which the data chunk is stored. In another embodiment, the map data segment may be stored in another memory block which is distinguishable from the memory block in which the data chunk is stored.

Hereinafter, referring to FIGS. 2 and 3, some operations performed by the memory system 110 are described in detail.

Referring to FIG. 2, a data processing system 100 in accordance with an embodiment of the disclosure is described. Referring to FIG. 2, the data processing system 100 may include a host 102 engaged with, or operably coupled to, a memory system 110.

The host 102 may include, for example, a portable electronic device such as a mobile phone, an MP3 player and a laptop computer, or a non-portable electronic device such as a desktop computer, a game player, a television (TV), a projector and the like.

The host 102 also includes at least one operating system (OS), which can generally manage, and control, functions and operations performed in the host 102. The OS can provide interoperability between the host 102 engaged with the memory system 110 and the user of the memory system 110. The OS may support functions and operations corresponding to a user's requests. By way of example but not limitation, the OS can be classified into a general operating system and a mobile operating system according to mobility of the host 102. The general operating system may be split into a personal operating system and an enterprise operating system according to system requirements or a user's environment. But the enterprise operating systems can be specialized for securing and supporting high performance computing. The mobile operating system may be subject to support services or functions for mobility (e.g., a power saving function). The host 102 may include a plurality of operating systems. The host 102 may execute multiple operating systems coupled with the memory system 110, corresponding to a user's request. The host 102 may transmit a plurality of commands corresponding to the user's requests into the memory system 110, thereby performing operations corresponding to commands within the memory system 110.

The controller 130 in the memory system 110 may control the memory device 150 in response to a request or a command input from the host 102. For example, the controller 130 may perform a read operation to provide a piece of data read from the memory device 150 to the host 102, and perform a write operation (or a program operation) to store a piece of data input from the host 102 in the memory device 150. In order to perform data input/output (I/O) operations, the controller 130 may control and manage internal operations for data read, data program, data erase, or the like.

According to an embodiment, the controller 130 can include a host interface 132, a processor 134, error correction circuitry 138, a power management unit (PMU) 140, a memory interface 142, and a memory 144. Components included in the controller 130 illustrated in FIG. 2 may vary according to implementation, desired operation performance, or other characteristics or considerations relevant to operation or use of the memory system 110. For example, the memory system 110 may be implemented with any of various types of storage devices, which may be electrically coupled with the host 102, according to a protocol of a host interface. Non-limiting examples of suitable storage devices include a solid state drive (SSD), a multimedia card (MMC) of an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, a memory stick, and the like. As noted above, one or more components in the controller 130 may be omitted or others added based on implementation of the memory system 110.

The host 102 and the memory system 110 may include a controller or an interface for transmitting and receiving a signal, a piece of data, and the like, under a specific protocol. For example, the host interface 132 in the memory system 110 may be configured to transmit a signal, a piece of data, and the like to the host 102 and/or receive a signal, a piece of data, and the like output from the host 102.

The host interface 132 in the controller 130 may receive a signal, a command (or a request), or a piece of data output from the host 102. That is, the host 102 and the memory system 110 may use a set protocol to exchange data. Examples of protocols or interfaces supported by the host 102 and the memory system 110 for exchanging data include Universal Serial Bus (USB), Multi-Media Card (MMC), Parallel Advanced Technology Attachment (PATA), Small Computer System Interface (SCSI), Enhanced Small Disk interface (ESDI), Integrated Drive Electronics (IDE), Peripheral Component Interconnect Express (PCIE), Serial-attached SCSI (SAS), Serial Advanced Technology Attachment (SATA), Mobile Industry Processor Interface (MIPI), and the like. According to an embodiment, the host interface 132 is a kind of layer for exchanging a piece of data with the host 102 and is implemented with, or driven by, firmware called a host interface layer (HIL).

The integrated Drive Electronics (IDE) or Advanced Technology Attachment (ATA), one of the interfaces for transmitting and receiving a piece of data, can use a cable including 40 wires connected in parallel to support data transmission and reception between the host 102 and the memory system 110. When a plurality of memory systems 110 are connected to a single host 102, the plurality of memory systems 110 may be divided into a master and slaves by using a position or a dip switch to which the plurality of memory systems 110 are connected. The memory system 110 set as the master may be used as the main memory device. The IDE (ATA) has evolved into Fast-ATA, ATAPI, and Enhanced IDE (EIDE).

Serial Advanced Technology Attachment (SATA) is a kind of serial data communication interface that is compatible with various ATA standards of parallel data communication interfaces which is used by Integrated Drive Electronics (IDE) devices. The 40 wires in the IDE interface can be reduced to six wires in the SATA interface. For example, 40 parallel signals for the IDE can be converted into 6 serial signals for the SATA to be transmitted between each other. The SATA has been widely used because of its faster data transmission and reception rate and less resource consumption in the host 102 used for data transmission and reception. The SATA may support connection with up to 30 external devices to a single transceiver included in the host 102. In addition, the SATA can support hot plugging that allows an external device to be attached or detached from the host 102 even while data communication between the host 102 and another device is being executed. Thus, the memory system 110 can be connected or disconnected as an additional device, like a device supported by a universal serial bus (USB) even when the host 102 is powered on. For example, in the host 102 having an eSATA port, the memory system 110 may be freely detached like an external hard disk.

The Small Computer System Interface (SCSI) is a kind of serial data communication interface used for connection between a computer, a server, and/or another peripheral device. The SCSI can provide a high is transmission speed, as compared with other interfaces such as the IDE and the SATA. In the SCSI, the host 102 and at least one peripheral device (e.g., the memory system 110) are connected in series, but data transmission and reception between the host 102 and each peripheral device may be performed through a parallel data communication. In the SCSI, it is easy to connect to, or disconnect from, the host 102 a device such as the memory system 110. The SCSI can support connections of 15 other devices to a single transceiver included in host 102.

The Serial Attached SCSI (SAS) can be understood as a serial data communication version of the SCSI. In the SAS, not only the host 102 and a plurality of peripheral devices are connected in series, but also data transmission and reception between the host 102 and each peripheral device may be performed in a serial data communication scheme. The SAS can support connection between the host 102 and the peripheral device through a serial cable instead of a parallel cable, so as to easily manage equipment using the SAS and enhance or improve operational reliability and communication performance. The SAS may support connections of eight external devices to a single transceiver included in the host 102.

The Non-volatile memory express (NVMe) is a kind of interface based at least on a Peripheral Component Interconnect Express (PCIe) designed to increase performance and design flexibility of the host 102, servers, computing devices, and the like equipped with the non-volatile memory system 110. Here, the PCIe can use a slot or a specific cable for connecting the host 102, such as a computing device, and the memory system 110, such as a peripheral device. For example, the PCIe can use a plurality of pins (for example, 18 pins, 32 pins, 49 pins, 82 pins, etc.) and at least one wire (e.g. x1, x4, x8, x16, etc.), to achieve high speed data communication over several hundred MB per second (e.g. 250 MB/s, 500 MB/s, 985 MB/s, 1969 MB/s, and etc.). According to an embodiment, the PCIe scheme may achieve bandwidths of tens to hundreds of Giga bits per second. A system using the NVMe can make the most of an operation speed of the non-volatile memory system 110, such as an SSD, which operates at a higher speed than a hard disk.

According to an embodiment, the host 102 and the memory system 110 may be connected through a universal serial bus (USB). The Universal Serial Bus (USB) is a kind of scalable, hot-pluggable plug-and-play serial interface that can provide cost-effective standard connectivity between the host 102 and a peripheral device such as a keyboard, a mouse, a joystick, a printer, a scanner, a storage device, a modem, a video camera, and the like. A plurality of peripheral devices such as the memory system 110 may be coupled to a single transceiver included in the host 102.

Referring to FIG. 2, the error correction circuitry 138 can correct error bits of the data to be processed in, and output from, the memory device 150, which may include an error correction code (ECC) encoder and an ECC decoder. Here, the ECC encoder can perform error correction encoding of data to be programmed in the memory device 150 to generate encoded data into which a parity bit is added and store the encoded data in memory device 150. The ECC decoder can detect and correct errors contained in data read from the memory device 150 when the controller 130 reads the data stored in the memory device 150. In other words, after performing error correction decoding on the data read from the memory device 150, the error correction circuitry 138 can determine whether the error correction decoding has succeeded and output an instruction signal (e.g., a correction success signal or a correction fail signal). The error correction circuitry 138 can use the parity bit which is generated during the ECC encoding process, for correcting error bit(s) of the read data. When the number of error bits is greater than or equal to a threshold number of correctable error bits, the error correction circuitry 138 might not correct error bits but instead may output an error correction fail signal indicating failure in correcting the error bits.

According to an embodiment, the error correction circuitry 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The error correction circuitry 138 may include any and all circuits, modules, systems, and/or devices for performing the error correction operation based on at least one of the above described codes.

For example, the ECC decoder may perform hard decision decoding and/or soft decision decoding on data transmitted from the memory device 150. Here, hard decision decoding can be understood as one of two methods (i.e., the hard decision decoding and the soft decision decoding) broadly classified for error correction. The hard decision decoding may include an operation of correcting an error by reading each bit or piece of digital data read from a non-volatile memory cell in the memory device 150 as either a ‘0’ or ‘1’ and correcting based on a known distance indicator. Because the hard decision decoding handles a binary logic signal, design and/or configuration of a circuit or algorithm for performing such decoding may be simple and processing speed may be faster than the soft decision decoding.

The soft decision decoding may quantize a threshold voltage of a non-volatile memory cell in the memory device 150 by two or more quantized values (e.g., multiple bit data, approximate values, an analog value, and the like) to correct an error based on the two or more quantized values. The controller 130 can receive two or more quantized values from a plurality of non-volatile memory cells in the memory device 150, and then perform decoding based on information generated by characterizing the quantized values as a combination of information such as conditional probability or likelihood.

According to an embodiment, the ECC decoder may use low-density parity-check and generator matrix (LDPC-GM) code among methods designed for soft decision decoding. Here, the low-density parity-check (LDPC) code uses an algorithm that can read values of data from the memory device 150 in several bits according to reliability, not simply data of 1 or 0 like hard decision decoding, and iteratively repeats the process through message exchange to improve reliability of the values, and then finally bit as 1 or 0. For example, a decoding algorithm using LDPC codes can be understood as a probabilistic decoding. In hard decision decoding a value output from a non-volatile memory cell is coded as 0 or 1. Compared to hard decision decoding, soft decision decoding can determine the value stored in the non-volatile memory cell based on the stochastic information. Regarding bit-flipping which may considered an error that can occur in the memory device 150, the soft decision decoding may provide improved probability of correcting an error and recovering data, as well as provide reliability and stability of corrected data. The LDPC-GM code may have a scheme in which internal LDGM codes can be concatenated in series with high-speed LDPC codes.

According to an embodiment, the ECC decoder may use a known low-density parity-check convolutional code (LDPC-CC) among methods designed for soft decision decoding. Herein, the LDPC-CC may employ linear time encoding and pipeline decoding based on a variable block length and a shift register.

According to an embodiment, the ECC decoder may use a Log Likelihood Ratio Turbo Code (LLR-TC) among methods designed for soft decision decoding. Herein, the Log Likelihood Ratio (LLR) may be calculated as a non-linear function to obtain a distance between a sampled value and an ideal value. In addition, Turbo Code (TC) may include a simple code (for example, a Hamming code) in two or three dimensions, and repeat decoding in a row direction and a column direction to improve reliability of values.

The power management unit (PMU) 140 may control electrical power provided in the controller 130. The PMU 140 may monitor the electrical power supplied to the memory system 110 (e.g., a voltage supplied to the controller 130) and provide the electrical power to components in the controller 130. The PMU 140 can not only detect power-on or power-off, but also generate a trigger signal to enable the memory system 110 to urgently back up a current state when the electrical power supplied to the memory system 110 is unstable. According to an embodiment, the PMU 140 may include a device or a component capable of accumulating electrical power that may be used in an emergency.

The memory interface 142 may serve as an interface for handling commands and data transferred between the controller 130 and the memory device 150 to allow the controller 130 to control the memory device 150 in response to a command or a request input from the host 102. The memory interface 142 may generate a control signal for the memory device 150 and may process data input to, or output from, the memory device 150 under the control of the processor 134 in a case when the memory device 150 is a flash memory. For example, when the memory device 150 includes a NAND flash memory, the memory interface 142 includes a NAND flash controller (NFC). The memory interface 142 can provide an interface for handling commands and data between the controller 130 and the memory device 150. In accordance with an embodiment, the memory interface 142 can be implemented through, or driven by, firmware called a Flash Interface Layer (FIL) as a component for exchanging data with the memory device 150.

According to an embodiment, the memory interface 142 may support an open NAND flash interface (ONFi), a toggle mode or the like for data input/output with the memory device 150. For example, the ONFi may use a data path (e.g., a channel, a way, etc.) that includes at least one signal line capable of supporting bi-directional transmission and reception in a unit of 8-bit or 16-bit data. Data communication between the controller 130 and the memory device 150 can be achieved through at least one interface regarding an asynchronous single data rate (SDR), a synchronous double data rate (DDR), and a toggle double data rate (DDR).

The memory 144 may be a working memory in the memory system 110 or the controller 130, storing temporary or transactional data received or delivered for operations in the memory system 110 and the controller 130. For example, the memory 144 may temporarily store a piece of read data output from the memory device 150 in response to a request from the host 102, before the piece of read data is output to the host 102. In addition, the controller 130 may temporarily store a piece of write data input from the host 102 in the memory 144, before programming the piece of write data in the memory device 150. When the controller 130 controls operations such as data read, data write, data program, data erase or etc. of the memory device 150, a piece of data transmitted or generated between the controller 130 and the memory device 150 of the memory system 110 may be stored in the memory 144. In addition to the piece of read data or write data, the memory 144 may store information (e.g., map data, read requests, program requests, etc.) for performing operations for inputting or outputting a piece of data between the host 102 and the memory device 150. According to an embodiment, the memory 144 may include a command queue, a program memory, a data memory, a write buffer/cache, a read buffer/cache, a data buffer/cache, a map buffer/cache, and the like.

In an embodiment, the memory 144 may be implemented with a volatile memory. For example, the memory 144 may be implemented with a static random access memory (SRAM), a dynamic random access memory (DRAM), or both. Although FIGS. 1 and 2 illustrate, for example, that the memory 144 is disposed within the controller 130, the invention is not limited to that arrangement. In another embodiment, the memory 144 may be disposed external to the controller 130. For instance, the memory 144 may be embodied by an extern& volatile memory having a memory interface transferring data and/or signals between the memory 144 and the controller 130.

The processor 134 may control overall operation of the memory system 110. For example, the processor 134 can control a program operation or a read operation of the memory device 150, in response to a write request or a read request input from the host 102. According to an embodiment, the processor 134 may execute firmware to control the program operation or the read operation in the memory system 110. Herein, the firmware may be referred to as a flash translation layer (FTL). An example of the FTL is later described in detail, referring to FIG. 3. According to an embodiment, the processor 134 may be implemented with a microprocessor or a central processing unit (CPU).

According to an embodiment, the memory system 110 may be implemented with at least one multi-core processor. The multi-core processor is a circuit or chip in which two or more cores, which are considered distinct processing regions, are integrated. For example, when a plurality of cores in the multi-core processor drive or execute a plurality of flash translation layers (FTLs) independently, data input/output speed (or performance) of the memory system 110 may be improved. According to an embodiment, the data input/output (I/O) operations in the memory system 110 may be independently performed through different cores in the multi-core processor.

The processor 134 in the controller 130 may perform an operation corresponding to a request or a command input from the host 102. Further, the memory system 110 may operate independently of a command or a request input from an external device such as the host 102. Typically, an operation performed by the controller 130 in response to the request or the command input from the host 102 may be considered a foreground operation, while an operation performed by the controller 130 independently (e.g., without a request or command input from the host 102) may be considered a background operation. The controller 130 can perform the foreground or background operation for read, write or program, erase and the like regarding a piece of data in the memory device 150. In addition, a parameter set operation corresponding to a set parameter command or a set feature command as a set command transmitted from the host 102 may be considered a foreground operation. As a background operation, the controller 130 can perform garbage collection (GC), wear leveling (WL), bad block management for identifying and processing bad blocks, or the like, in relation to a plurality of memory blocks 152, 154, 156 in the memory device 150.

According an embodiment, substantially similar operations may be performed as both a foreground operation and a background operation. For example, if the memory system 110 performs garbage collection in response to a request or a command input from the host 102 (e.g., Manual GC), garbage collection can be considered a foreground operation. However, when the memory system 110 performs garbage collection independently of the host 102 (e.g., Auto GC), garbage collection can be considered a background operation.

When the memory device 150 includes a plurality of dies (or a plurality of chips) including non-volatile memory cells, the controller 130 may be configured to perform parallel processing regarding plural requests or commands input from the host 102 in to improve performance of the memory system 110. For example, the transmitted requests or commands may be distributed to, and processed in parallel within, a plurality of dies or a plurality of chips in the memory device 150. The memory interface 142 in the controller 130 may be connected to a plurality of dies or chips in the memory device 150 through at least one channel and at least one way, When the controller 130 distributes and stores pieces of data in the plurality of dies through each channel or each way in response to requests or commands associated with a plurality of pages including non-volatile memory cells, plural operations corresponding to the requests or the commands can be performed simultaneously or in parallel. Such a processing method or scheme can be considered as an interleaving method. Because data input/output speed of the memory system 110 operating with the interleaving method may be faster than that without the interleaving method, data I/O performance of the memory system 110 can be improved.

By way of example but not limitation, the controller 130 can recognize the status of each of a plurality of channels (or ways) associated with a plurality of memory dies in the memory device 150. For each channel/way, the controller 130 may determine it to have a busy status, a ready status, an active status, an idle status, a normal status, and/or an abnormal status. The controller's determination of which channel or way an instruction (and/or a data) is delivered through can be associated with a physical block address, e.g., to which die(s) the instruction (and/or the data) is delivered. For such determination, the controller 130 can refer to descriptors delivered from the memory device 150. The descriptors, which are data with a specific format or structure can include a block or page of parameters that describe a characteristic or the like about the memory device 150. For instance, the descriptors may include device descriptors, configuration descriptors, unit descriptors, and the like. The controller 130 can refer to, or use, the descriptors to determine via which channel(s) or way(s) an instruction or a data is exchanged.

Referring to FIG. 2, the memory device 150 in the memory system 110 may include the plurality of memory blocks 152, 154, 156, each of which includes a plurality of non-volatile memory cells. According to an embodiment, a memory block can be a group of non-volatile memory cells erased together. Each memory block 152, 154, 156 may include a plurality of pages which is a group of non-volatile memory cells read or programmed together. Although not shown in FIG. 2, each memory block 152, 154, 156 may have a three-dimensional stack structure for high integration. Further, the memory device 150 may include a plurality of dies, each die including a plurality of planes, each plane including the plurality of memory blocks. Configuration of the memory device 150 may vary depending on performance or use of the memory system 110. The plurality of memory blocks 152, 154, 156 may be included in the plurality of memory blocks 60 shown in FIG. 1.

In the memory device 150 shown in FIG. 2, the plurality of memory blocks 152, 154, 156 can be any of different types of memory blocks such as a single-level cell (SLC) memory block, a multi-level cell (MLC) memory block, or the like, according to the number of bits that can be stored or represented in one memory cell of a given memory block. Here, the SLC memory block includes a plurality of pages implemented by memory cells, each storing one bit of data. The SLC memory block can have high data I/O operation performance and high durability. The MLC memory block includes a plurality of pages implemented by memory cells, each storing mufti-bit data (e.g., two bits or more). The MLC memory block can have larger storage capacity for the same space compared to the SLC memory block. The MLC memory block can be highly integrated in a view of storage capacity. In an embodiment, the memory device 150 may be implemented with MLC memory blocks such as double level cell (DLC) memory blocks, triple-level cell (TLC) memory blocks, quadruple-level cell (QLC) memory blocks or combination thereof. The double-level cell (DLC) memory block may include a plurality of pages implemented by memory cells, each capable of storing 2-bit data. The triple-level cell (TLC) memory block can include a plurality of pages implemented by memory cells, each capable of storing 3-bit data. The quadruple-level cell (QLC) memory block can include a plurality of pages implemented by memory cells, each capable of storing 4-bit data. In another embodiment, the memory device 150 can be implemented with a block including a plurality of pages implemented by memory cells, each capable of storing five or more bits of data.

According to an embodiment, the controller 130 may use a multi-level cell (MLC) memory block in the memory device 150 as an SLC memory block that stores one-bit data in one memory cell. Data input/output speed of the multi-level cell (MLC) memory block can be slower than that of the SLC memory block. That is, when the MLC memory block is used as the SLC memory block, for the speed at which a read or program operation is performed can be increased. The controller 130 can utilize a faster data input/output speed of the multi-level cell (MLC) memory block when using the multi-level cell (MLC) memory block as the SLC memory block. For example, the controller 130 can use the MLC memory block as a buffer to temporarily store a piece of data, because the buffer may require a high data input/output speed for improving performance of the memory system 110.

Further, according to an embodiment, the controller 130 may program pieces of data in a multi-level cell (MLC) a plurality of times without performing an erase operation on a specific MLC memory block in the memory device 150. In general, non-volatile memory cells have a feature that does not support data overwrite. However, the controller 130 may use a feature in which a multi-level cell (MLC) may store multi-bit data, in order to program plural pieces of 1-bit data in the MLC a plurality of times. For MLC overwrite operation, the controller 130 may store the number of program times as separate operation information when a piece of 1-bit data is programmed in a non-volatile memory cell. According to an embodiment, an operation for uniformly levelling threshold voltages of non-volatile memory cells can be carried out before another piece of data is overwritten in the same non-volatile memory cells.

In an embodiment of the disclosure, the memory device 150 is embodied as a non-volatile memory such as a flash memory, for example, as a NAND flash memory, a NOR flash memory, and the like. Alternatively, the memory device 150 may be implemented by at least one of a phase change random access memory (PCRAM), a ferroelectrics random access memory (FRAM), a spin injection magnetic memory (STT-RAM), and a spin transfer torque magnetic random access memory (STT-MRAM), or the like.

Referring to FIG. 3, a controller 130 in a memory system 110 in accordance with another embodiment of the disclosure is described. The controller 130 cooperates with the host 102 and the memory device 150. As illustrated, the controller 130 includes a flash translation layer (FTL) 240, as well as the host interface 132, the memory interface 142, and the memory 144 of FIG. 2.

Although not shown in FIG. 3, in accordance with an embodiment, the ECC 138 illustrated in FIG. 2 may be included in the flash translation layer (FTL) 240. In another embodiment, the ECC 138 may be implemented as a separate module, a circuit, firmware, or the like, which is included in, or associated with, the controller 130.

The host interface 132 is for handling commands, data, and the like transmitted from the host 102. By way of example but not limitation, the host interface 132 may include a command queue 56, a buffer manager 52, and an event queue 54. The command queue 56 may sequentially store commands, data, and the like received from the host 102 and output them to the buffer manager 52 in an order in which they are stored. The buffer manager 52 may classify, manage, or adjust the commands, the data, and the like, which are received from the command queue 56. The event queue 54 may sequentially transmit events for processing the commands, the data, and the like received from the buffer manager 52.

A plurality of commands or data of the same type, e.g., read or write commands, may be transmitted from the host 102, or commands and data of different types may be transmitted to the memory system 110 after being mixed or jumbled by the host 102. For example, a plurality of commands for reading data (read commands) may be delivered, or commands for reading data (read command) and programming/writing data (write command) may be alternately transmitted to the memory system 110. The host interface 132 may store commands, data, and the like, which are transmitted from the host 102, to the command queue 56 sequentially. Thereafter, the host interface 132 may estimate or predict what kind of internal operation the controller 130 will perform according to the types of commands, data, and the like, which have been received from the host 102. The host interface 132 can determine a processing order and a priority of commands, data and the like, based at least on their characteristics. According to characteristics of commands, data, and the like transmitted from the host 102, the buffer manager 52 in the host interface 132 is configured to determine whether the buffer manager should store commands, data, and the like in the memory 144, or whether the buffer manager should deliver the commands, the data, and the like into the flash translation layer (FTL) 240. The event queue 54 receives events, received from the buffer manager 52, which are to be internally executed and processed by the memory system 110 or the controller 130 in response to the commands, the data, and the like transmitted from the host 102, so as to deliver the events into the flash translation layer (FTL) 240 in the order received.

In accordance with an embodiment, the flash translation layer (FTL) 240 illustrated in FIG. 3 may work as a multi-thread scheme to perform the data input/output (I/O) operations. A multi-thread FTL may be implemented through a multi-core processor using multi-thread included in the controller 130.

In accordance with an embodiment, the flash translation layer Is (FTL) 240 can include a host request manager (HRM) 46, a map manager (MM) 44, a state manager 42, and a block manager 48. The host request manager (HRM) 46 can manage the events entered from the event queue 54. The map manager (MM) 44 can handle or control a map data. The state manager 42 can perform garbage collection (GC) or wear leveling (WL). The block manager 48 can execute commands or instructions on a block in the memory device 150. The state manager 42 may include the retention control circuitry 192 shown in FIG. 1. Although not illustrated in FIG. 3, according to an embodiment, the error correction circuitry 138 described in FIGS. 1 and 2 may be included in the flash translation layer (FTL) 240. According to an embodiment, the error correction circuitry 138 may be implemented as a separate module, circuit, or firmware in the controller 130.

In addition, according to an embodiment, the flash translation layer (FTL) 240 may include the retention control circuitry 192 described in FIG. 1, the memory interface 142 may include the transceiver 198 described in FIG. 1.

By way of example but not limitation, the host request manager (HRM) 46 can use the map manager (MM) 44 and the block manager 48 to handle or process requests according to the read and program commands, and events which are delivered from the host interface 132. The host request manager (HRM) 46 can send an inquiry request to the map data manager (MM) 44 to determine a physical address corresponding to the logical address associated with the events. The host request manager (HRM) 46 can send a read request with the physical address to the memory interface 142, to process the read request (handle the events). On the other hand, the host request manager (FIRM) 46 can send a program request (write request) to the block manager 48, to program data to a specific empty page (no data) in the memory device 150, and then, can transmit a map update request corresponding to the program request to the map manager (MM) 44 to update an item or a chunk relevant to the programmed data pertaining to information for associating, or mapping, the logical-physical addresses with, or to, each other.

Here, the block manager 48 can convert a program request (delivered from the host request manager (HRM) 46, the map data manager (MM) 44, and/or the state manager 42 to a flash program request used for the memory device 150 to manage flash blocks in the memory device 150. In order to maximize or enhance program or write performance of the memory system 110 (see FIG. 2), the block manager 48 may collect program requests and send flash program requests for multiple-plane and one-shot program operations to the memory interface 142. In an embodiment, the block manager 48 sends several flash program requests to the memory interface 142 to enhance or maximize parallel processing of the multi-channel and multi-directional flash controller.

On the other hand, the block manager 48 can be configured to manage blocks in the memory device 150 according to the number of valid pages, select and erase blocks having no valid pages when a free block is needed, and select a block including the least number of valid pages when it is determined that garbage collection is necessary or desirable. The state manager 42 can perform garbage collection to move the valid data to an empty block and erase the blocks from which the valid data was moved so that the block manager 48 may have enough free blocks (empty blocks with no data). If the block manager 48 provides information regarding a block to be erased to the state manager 42, the state manager 42 could check all flash pages of the block to be erased to determine whether each page is valid. For example, to determine validity of each page, the state manager 42 can identify a logical address recorded in an out-of-band (OOB) area of each page. To determine whether each page is valid, the state manager 42 can compare the physical address of the page with the physical address mapped to the logical address obtained from the inquiry request. The state manager 42 sends a program request to the block manager 48 for each valid page. A mapping table can be updated through the update of the map manager 44 when the program operation is complete.

The map manager 44 can manage a logical-physical mapping table. The map manager 44 can process requests such as queries, updates, and the like, which are generated by the host request manager (HRM) 46 or the state manager 42. The map manager 44 may store the entire mapping table in the memory device 150 (e.g., a flash/non-volatile memory) and cache mapping entries according to the storage capacity of the memory 144. When a map cache miss occurs while processing inquiry or update requests, the map manager 44 may send a read request to the memory interface 142 to load a relevant mapping table stored in the memory device 150. When the number of dirty cache blocks in the map manager 44 exceeds a certain threshold, a program request can be sent to the block manager 48 so that a dean cache block is made and the dirty map table may be stored in the memory device 150.

On the other hand, when garbage collection is performed, the state manager 42 copies valid page(s) into a free block, and the host request manager (HRM) 46 can program the latest version of the data for the same logical address of the page and currently issue an update request. When the status manager 42 requests the map update in a state in which copying of valid page(s) is not properly completed, the map manager 44 might not perform the mapping table update. It is because the map request is issued with old physical information if the status manger 42 requests a map update and a valid page copy is completed later, The map manager 44 may perform a map update operation to ensure accuracy only if the latest map table still points to the old physical address.

FIG. 4 illustrates a data chunk and a map data segment stored in a memory device according to an embodiment of the disclosure.

Referring to FIGS. 1 to 4, the plurality of memory blocks 60 in the memory device 150 may include the first cache memory block 62 and the second memory block 66. For example, the first cache memory block 62 may be used as a cache memory for storing data temporarily, and the second memory block 66 may be used as a main storage for storing data permanently. Although the cache memory may have a slower operation speed than that of the host 102, the cache memory may operate faster than the second memory block 66 used as the main storage device. The cache memory may be allocated to load or store an application program, firmware, data, operation information, and like, which can be frequently used by the host 102 or the controller 130. In an embodiment, the cache memory may be accessed frequently by the host 102 or the controller 130. On the other hand, the main storage including the second memory block 66 can be allocated to store data generated or transmitted by the host 102 and the controller 130 permanently or for a long time. The host 102 or the controller 130 may first access the cache memory before accessing the main storage, and the host 102 or the controller 130 can use data stored in the cache memory with higher priority than that stored in the main storage.

The first cache memory block 62 may require faster input/output of data than the second memory block 66. The first cache memory block 62 may store a first user data chunk and a first map data segment associated with the first user data chunk, and the second memory block 66 may store a second user data chunk and a second map data segment associated with the second user data chunk. When a size of the first user data chunk read from or programmed to the first cache memory block 62 is less than a size of the second user data chunk read from or programmed the second memory block 66, an operation speed of the first cache memory block 62 can be faster than that of the second memory block 66. Accordingly, a size of the first user data chunk corresponding to the first map data segment may be less than a size of the second user data chunk corresponding to the second map data segment. Even though the first user data chunk and the second user data chunk may be read or programmed on a page-by-page basis from the first cache memory block 62 and the second memory block 66, respectively, a single second map data segment (L2P segment) can correspond to, or be associated with, plural data chunks stored in the plural pages of the second memory block 66.

According to an embodiment, the first map data segment and the second map data segment may be stored in a third memory block (not shown) which is distinguishable from the first cache memory block 62 and the second memory block 66.

On the other hand, according to an embodiment, the first cache memory block 62 may be required to perform a faster data input/output operation than the second memory block 66, so that the first cache memory block 62 and the second memory block 66 may have different internal configurations. For example, the first cache memory block 62 may include a single-level memory cell (SLC), while the second memory block 66 may include a mufti-level memory cell (MLC). If the first cache memory block 62 is a single-level cell (SLC) memory block, the first data chunk having a size of one page may be output or input while a single word line WL_a is activated. When the first map data segment corresponds to the first data chunk stored in a single page, a single first map data segment may be updated after the first data chunk is stored in one page.

For example, when the second memory block 66 is a quadruple-level memory cell (QLC) type, the second user data chunk having a size of four pages (4-page) can be output while a single word line WL_b is activated. Even though the second user data chunk may be read or programmed on a page-by-page basis from the second memory block 66, a single second map data segment (L2P segment) can correspond to, be associated with, plural data chunks stored in the plural pages of the second memory block 66. In the second memory block 66, the second map data segment may be associated with data corresponding to word lines in order to store more data chunk therein. When a single second map data segment corresponds to the second user data chunk having a size of 16 pages (e.g., data chunks stored in quadruple-level memory cells coupled via four word lines), the second map data segment may be updated after the second user data chunk is programmed.

As described above, a size of data chunk programmed once (through one-time program operation) can be different based at least on internal configurations of the first cache memory block 62 and the second memory block 66, the first and second map data segments associated with the first and second data chunks stored in the first cache memory block 62 and the second memory block 66, or the number of word lines corresponding to data chunks read from or programmed to the first cache memory block 62 or the second memory block 66.

Referring to FIGS. 1 and 4, the second data chunk having a size of 16 pages corresponding to a single second map data segment, which is stored in the second memory block 66 selected by the retention control circuitry 192 can be read and stored in the memory 144. The error correction circuitry 138 may check whether there is an error in the data chunk having a size of 16 pages. It is assumed that the error correction circuitry 138 detects an error in a segment, i.e., a portion, of the second data chunk having a size of 16 pages, the segment (portion) corresponding to one page only, and finds no errors in the remaining 15 pages of the second user data chunk. The error correction circuitry 138 may correct the error detected. When all of the second data chunk having a 16-page size is stored in another second memory block 66 in the memory device 160, that amount of data to be programmed in the memory device 150 is large. On the other hand, in an embodiment of the disclosure, because there are no errors in 15 of the 16 pages of the second data chunk, the 15 pages of data stored in the second memory block 66 need not be changed or copied to another location. Only the single page in which the error is detected and corrected may be copied in the first cache memory block 62. Through this procedure, a write amplification factor (WAF) of the memory system 110 may be reduced. Overhead in the memory system 110 caused by an operation of copying an entire data chunk can be reduced. Further, a program/eraser cycle (P/E cycle) of the second memory block 66 in the memory device 150 may be reduced or increase more slowly. Thus, durability or endurance of the memory device 150 may be improved.

FIG. 5 describes a first example of a method for operating a memory system according to an embodiment of the disclosure.

Referring to FIG. 5, the method for operating a memory system 110 can include selecting a memory block, e.g., second memory block 66 shown in FIG. 1, for checking data safety based on an operational status of the selected memory block in the memory device (342), determining an error level of data stored in the selected memory block (344), and storing error-corrected data in a cache memory block, e.g., first cache memory block 62 shown in FIG. 1, based on the error level (346).

Referring to FIGS. 1 to 5, the controller 130 may check the operational status of the second memory block 66 to improve safety of data stored in the second memory block 66 in the memory device 150. For example, the controller 130 may check a program/erase cycle (P/E cycle) and a data retention time of each second memory block 66. The controller 130 uses the program/erase cycle and the data retention time corresponding to each second memory block 66 among a plurality of memory blocks 60 in the memory device 150 to select a second memory block 66 in which data safety is relatively lower (342).

After reading data stored in the selected second memory block 66, the controller 130 may check whether the read data includes an error (344). Referring to FIG, 4, the controller 130 may read the second user data chunk stored in the second memory block 66 based on the second map data segment, and then store the read second user data chunk in the memory 144. Referring to FIGS. 1 and 2, the error correction circuitry 138 in the controller 130 may check whether the second user data chunk stored in the memory 144 includes an error. Depending on an embodiment, the controller 130 may determine an error level of the second user data chunk as one of four types: an uncorrectable error, a high level error, a not-high level error, and no error based on an error detected in the read second user data chunk. The error level is described below with reference to FIG. 10.

When the error level of the second user data chunk is determined, the controller 130 may copy some of the second user data chunk to another location based on the error level (346). According to an embodiment, in order to improve the safety of the second user data chunk, the controller 130 may program error-corrected data to a new location (e.g., the first cache memory block 62) or refresh plural memory cells of the second memory block 66, which originally store the error-corrected data without an erase operation. Specifically, when programming the error-corrected data in the second user data chunk into a new location (e.g., the first cache memory block 62 or another second memory block 66), the controller 130 may determine whether to program the entire second user data chunk or only a portion thereof in the new location, according to a range in which an error is detected in the second user data chunk. For example, after reading the second user data chunk corresponding to 16 pages, when an error is found in a relatively large portion of the data, i.e., 10 pages, the entire second user data chunk corresponding to all 16 pages can be programmed at a new second memory block 66 in the main storage can increase data stability. On the other hand, when an error is found in a relatively small portion of the data, i.e., one or two pages of the entire 16 pages, the controller 130 may not program the entire second user data chunk. Rather, the controller 130 may program only the portion corresponding to the one or two pages which the error was detected in the first cache memory block 62, which is designated as a new location.

According to an embodiment, after correcting the detected error in the second user data chunk, the controller 130 may copy the entire second user data chunk at a new location in the main storage or a part of the data in the first cache memory block 62 instead of the main storage, in response to the error level of the second user data chunk. A criterion for determining whether the controller 130 copies a portion of a second user data chunk in the first cache memory block 62 may be set according to an error level found in the second user data chunk and the first map data segment corresponding to the first user data chunk to be stored in the first cache memory block 62. For example, when an error is detected and corrected in less than 20% of a read second user data chunk, the controller 130 may copy only the corrected portion in the first cache memory block 62. Conversely, when an error is found and corrected in more than 20% of the second user data chunk, the controller 130 may copy the entire second user data chunk in another second memory block 66 in the main storage to improve data safety or data protection. Further, the criterion (i.e., the error level of the read second user data chunk) may be set based on a capability for error correction in the memory system 110 and an operational status of the second memory block 66 in the memory device 150 (e.g., a data retention time, durability/endurance or the like). The memory system 110 may occasionally or dynamically change the criterion in response to a program-eraser cycle (P/E cycle) of memory block, which is a kind of operation information regarding the memory device 150. For another example, when a map data segment can be associated with a data chunk, having a two-page size, stored in a cache memory block, the controller 130 may select a portion of the second user data chunk, corresponding to the two pages, after correcting an error detected at a single page of the second user data chunk. The portion of the second user data chunk, including an error-corrected data of the single page, can be programmed as the data chunk in the cache memory block. Thus, the criterion (e.g., a size of the first data chunk corresponding to the first map data segment to be stored in the first cache memory block 62) may be set based on the configuration of map data segments in the cache memory block.

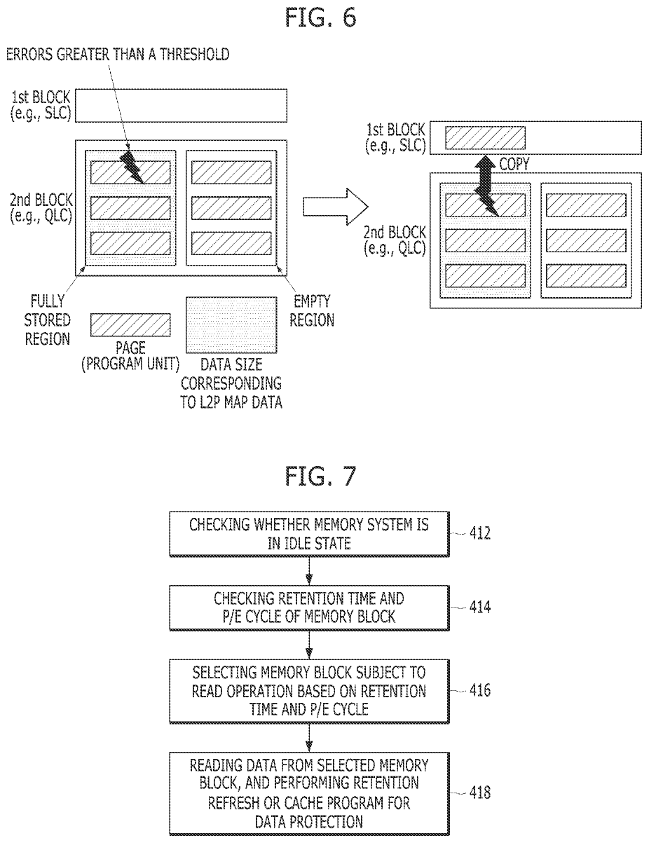

FIG. 6 illustrates a procedure for maintaining, protecting, or copying a data chunk stored in a memory device based on a data retention time.

Referring to FIG. 6, it is assumed that a plurality of second memory blocks 66 (e.g., QLC blocks) and a plurality of first memory blocks 62 (e.g., SLC blocks) are included in the memory device 150 shown in FIG. 1. The first map data segment (e.g., L2P segment) of the first cache memory block 62 may associate a logical address with a physical address of a smaller first user data chunk than the second map data segment of the second memory block 66. The second map data segment of the second memory block 66 can associate a logical address with a physical address for the second user data chunk stored in the second memory block 66 configured by 16 pages, and the first map data segment of the first cache memory block 62 can associate a logical address with a physical address for the first user data chunk stored in the first cache memory block 62 configured by a single page. Here, the second memory block 66 is used as a main storage, while the first cache memory block 62 is used as a cache memory block. Even though the first user data chunk and the second user data chunk may be programmed on a page-by-page basis in the first cache memory block 62 and the second memory block 66 individually, a single second map data segment (L2P segment) associated with the second user data chunk stored in the second memory block 66 can correspond to data chunks programmed in the plural pages configuring the second memory block 66. The controller 130 may sequentially read data chunks of the second user data chunk stored in plural pages of the second memory block 66, which is dosed, and check whether there is an error in the second user data chunk stored in the plural pages corresponding to a single second map data segment (L2P segment). Errors of more than a threshold may have occurred in a portion of the second user data chunk read from plural pages, so that the memory system 110 performs an operation for data safety or protection, and the portion of the second user data chunk may have the size of a single page among the plural pages.

In an embodiment, the controller 130 may not copy the entire second user data chunk stored in the second memory block 66 to another second memory block 66, but may copy only an error-corrected portion (i.e., the portion of the second user data chunk) having a size of a single page in the second user data chunk to the first cache memory block 62 as the first user data chunk. The write amplification factor (WAF) of the memory system 110 can be reduced by copying only the portion of the second user data chunk in which errors are detected to the first cache memory block 62, instead of copying the entire of the second user data chunk. Overheads incurred in the memory system 110 while copying data to another location can be reduced. Further, increase of a program/eraser cycle (P/E cycle) of the second memory block 66 in the memory device 150 may be avoided, because garbage collection to the second memory block 66 might be postponed. Accordingly, the endurance of the memory device 150 may be improved.

FIG. 7 illustrates a second example of a method for operating a memory system 110 according to an embodiment of the disclosure.

Referring to FIG. 7, the method for operating the memory system 110 can include determining whether the memory system 110 is in an idle state (412), checking a data retention time and a program-eraser cycle (P/E Cycle) of a second memory block 66 (414), selecting a second memory block 66 subject to read operation based on a data retention time (Retention time) and a program-eraser cycle (P/E Cycle) (416), and reading the second user data chunk from the selected second memory block 66 and performing a retention refresh or a cache program for data protection (418).

When receiving a request for data input/output operation from an external device (e.g., the host 102 shown in FIGS. 2 to 3), the memory system 110 may perform an operation corresponding to the request. If there is no request from the external device, the memory system 110 may enter an idle state. After the memory system 110 enters the idle state, the memory system 110 may perform a background operation to improve operation performance of the memory system 110 (412). As a kind of background operation, the memory system 110 can check whether there is an error in the second user data chunk stored in the second memory block 66 to improve protection or safety of the second user data chunk.

In order for the controller 130 to maintain or improve the safety of the second user data chunk stored in the second memory block 66, the operational status of the second memory block 66 may be checked (414). For example, the operational status of the second memory block 66 may be represented by a data retention time, a program-eraser cycle (P/E cycle) or the like. The memory device 150 may include a plurality of second memory blocks 66 shown in FIG. 1. When the controller 130 sequentially reads and checks second user data chunks stored in all the plurality of second memory blocks 66, operational efficiency may be lowered. A memory block in the memory device 150 may have an open state status in which data is been programmed, a dosed state status in which all pages are programmed with data, and an erased state status in which all data is deleted. In order to maintain or improve the safety of the second user data chunks, the controller 130 may first select the second memory block 66 having the longest data retention time, based on a length of time in the closed state, among the second memory blocks 66 in a closed state (416).

According to an embodiment, the plurality of second memory blocks 66 in the memory device 150 may have different program-eraser cycles (P/E cycles). The controller 130 may perform a wear level operation to reduce an increase in a difference between program-eraser cycles (P/E cycle) which may be used to indicate endurance of each second memory block 66. However, the program-eraser cycles (P/E cycle) of the second memory blocks 66 might not be the same. For example, when the data retention times of plural second memory blocks 66 in the dosed state are the same or substantially the same (no significant difference), the controller 130 may select a second memory block 66 having a larger program-eraser cycle (P/E cycle) therebetween (416).

After the controller 130 selects the second memory block 66 for checking or monitoring data safety, the second user data chunks stored in the selected second memory block 66 may be read (418). For example, the second user data chunks in the selected second memory block 66 may be sequentially read based on map data segments associated with the second user data chunks stored in the selected second memory block 66. The map data segments may include one or more second map data segment, shown in FIG. 4, which is associated with at least one second user data chunk stored in the second memory block 66. After reading the second user data chunk stored in the selected second memory block 66 based on the second map data segment, the controller 130 may check whether there is an error in the read second user data chunk and determine an error level of the read second user data chunk. In response to the error level of the read second user data chunk, the controller 130 may determine whether to refresh plural memory cells of the selected second memory block 66 in which the second user data chunk is stored or whether to copy or program the error-corrected data chunk in the first cache memory block 62 (418).

FIG. 8 graphically illustrates a data retention time with respect to endurance of the memory device. Specifically, FIG. 8 shows a relationship between the endurance and the data retention time of a second memory block 66 in the memory device 150. Numerical values shown in FIG. 8 are given as an example to aid understanding. In an embodiment, the values may vary according to an internal configuration and an operational status of the specific memory block. Herein, the endurance and the data retention time may be used as relevant performance indicators regarding the memory device 150.

Referring to FIG. 8, when a PIE cycle of the memory device 150 is 0 to 3000, a data retention time may be several years (X-year). That is, a data chunk stored in the memory device 150 may be maintained for several years (X-years) until the program-eraser cycle (P/E cycle) of the memory device 150 is up to about 3000. For example, for a data retention time of about 1, 3 or 5 years, the memory device 150 can safely maintain the data chunk.

While the program-eraser cycle (P/E cycle) of the memory device 150 is in the range of 3000 to 8000, the data retention time of data chunk stored in the memory device 150 can be several months (X-months). For example, a data chunk stored in the memory device 150 may be safely maintained during a data retention time of about 1, 3 or 5 months.

While the program-eraser cycle (P/E cycle) of the memory device 150 is in the range of 8000 to 20000, the data retention time of data chunk stored in the memory device 150 can be several weeks (X-weeks). For example, the memory device 150 can safely maintain a data chunk for a retention time of about 1 week, 3 weeks, or 5 weeks.

While the program-eraser cycle (P/E cycle) of the memory device 150 falls in the range of 20000 to 150000, the data retention time of a data chunk stored in the memory device 150 can be several days (X-days). For example, a data chunk stored in the memory device 150 may be safely maintained during a data retention time of about 1, 3 or 5 days.

Referring to FIG. 8, based on the endurance of the memory device 150, the data retention time in which data can be safely retained may differ considerably. Accordingly, the controller 130 may perform an operation for improving the data safety based on the endurance of the memory device 150.

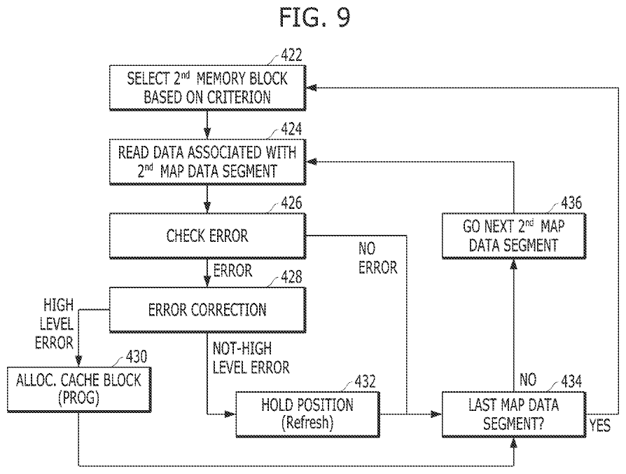

FIG. 9 illustrates a third example of a method for operating a memory system 110 according to an embodiment of the disclosure.

Referring to FIG. 9, the method for operating a memory system 110 may include selecting a second memory block 66 based on a criterion (422). Herein, the second memory block 66 may be allocated for storing a data chunk in a main storage rather than a first cache memory block 62. Referring to FIGS. 7 to 8, the controller 130 can select the second memory block 66 in which data safety is to be checked based on an operational status of the second memory block 66.

The method for operating the memory system 110 may include reading a second user data chunk corresponding to a second map data segment from the second memory block 66 (424). In response to the second map data segment associated with the second user data chunk stored in the selected second memory block 66, an amount (or number) of data chunks (within the second user data chunk) read through a single read operation may be determined. For example, in order to increase operation efficiency of the memory device 150, the controller 130 may increase the amount of data chunks (in the second user data chunk) to be stored in the second memory block 66, and the second map data segment can be associated with the second user data chunk stored in a plurality of pages in the second memory block 66. In an embodiment, the data chunk can be stored in a plurality of non-volatile memory cells coupled to a plurality of word lines. The controller 130 may sequentially read second user data chunks from the second memory block 66, each second user data chunk corresponding to each second map data segment (424).

The method for operating the memory system 110 may include checking whether there is an error in the second user data chunk read through the read operation from the second memory block 66 (426). After reading the second user data chunk corresponding to the single second map data segment, the controller 130 may check whether there is an error in the second user data chunk. If there is no error in the second user data chunk (No Error), the controller 130 may check whether the second map data segment is the last one within second map data segments in the selected second memory block 66 (434).

When the second map data segment is the last one (YES in operation 434), the controller 130 can select another second memory block 66 based on the criterion (422). If the second map data segment is not the last one in the second map data segments in the selected second memory block 66 (NO in operation 434), the controller 130 may select the next second map data segment in the second map data segments in the selected second memory block 66 (436). When the next second map data segment is selected in the second map data segments in the selected second memory block 66, the controller 130 may read another data chunk corresponding to the selected second map data segment through operation 424.

The controller 130 can check whether there is an error in the second user data chunk stored in the selected second memory block 66 (426) and determine that an error may be included in the second user data chunk (‘ERROR’ in 426). When the second user data chunk includes an error, the controller 130 may correct the error to recover the second user data chunk (428). Further, in a process of correcting the error, the controller 130 may determine an error level of the second user data chunk. For example, the error level may be determined based on a range in which an error occurs in the second user data chunk, a resource consumed to correct the error, or the like, When the controller 130 can correct an error through a simple operation, it may determine that the error level is not high (‘NOT-HIGH LEVEL ERROR’ in 428). On the other hand, when the controller 130 can correct an error through a complex operation or algorithm (which consumes a lot of resources for error correction), the controller 130 may determine that the error level is high (‘HIGH LEVEL ERROR’ IN 428). The error level is described below with reference to FIG. 10.

When determining that the error level is not high, the controller 130 may maintain a current position (i.e., the selected second memory block 66) in which the second user data chunk is stored (432). Herein, the maintaining the current location in which the second user data chunk is stored may mean that the second user data chunk is not copied to a new location. According to an embodiment, even when an error is found in the current position of the second user data chunk but the error is not serious (e.g., easily corrected), the controller 130 may refresh non-volatile memory cells arranged at the corresponding position, based on the corrected second user data chunk.

When it is determined that the error level is high, the controller 130 may copy the data chunk to a new location (430). For example, when a high-level error detected in a portion of the second user data chunk is corrected, the controller 130 may copy the error-corrected data chunk to the first cache memory block 62 allocated for a cache memory (430). Although not shown, when the high-level error is detected in the second user data chunk at large, the controller 130 may copy the entire second user data chunk to another second memory block 66 used as a main storage.

After correcting the error included in the data chunk (428), the controller 130 may perform a program operation to a new location (430) or refreshing non-volatile memory cells at the current location (432), based on the error level. Then, the controller 130 may check whether the map data segment is the last one in the second map data segments in the selected second memory block 66 (434). When the sub-map data segment is the last one (YES in operation 434), the controller 130 can select another second memory block 66 for securing data safety or data protection. When the map data segment is not the last one in the second map data segments in the selected second memory block 66 (NO in operation 434), the controller 130 can read another second user data chunk corresponding to the next second map data segment or another second map data segment in the selected second memory block 66 (436). When the next map data segment is selected in the second map data segments in the selected second memory block 66, the controller 130 may read another second user data chunk corresponding to the selected map data segment through the operation 424.

FIG. 10 illustrates an example of how to determine the error level of the read data chunk in the second user data chunk.

Referring to FIG. 10, the error level may be classified into one of four types. First, there is a case where there is no error in the data chunk (NO ERROR). The controller 130 reads the second user data chunk stored in the second memory block 66 and checks whether an error is included in the data chunk (SCAN & CHECK). When there is no error, the controller 130 may perform a scan and check operation only.

In addition, there is an uncorrectable ECC (UECC) error as one of the error levels. Even though the maximum error recovery capability that the controller 130 can perform is used to correct an error detected in the data chunk (ECC Max. Performance), the error may be not corrected and the data chunk may be not recovered. When the error level is determined to be an unrecovered error (UECC Error), the controller 130 may notify the host 102 (see FIGS. 2 to 3) of such information regarding the data chunk. In the method for operating the memory system 110 according to an embodiment of the (disclosure, the controller 130 can try to periodically perform an operation for checking the data safety so as to avoid an unrecovered error (UECC Error) from the second user data chunk stored in the second memory block 66.

There is also a high-level error and a not high-level error. In a case where the error level is not high, the controller 130 may detect an error in the data chunk but can easily correct the error. On the other hand, when the error level is high, the controller 130 may use a lot of resources (time, power, etc.) to correct the error detected in the data chunk. A criterion for distinguishing between the high-level error and the not high-level error can be established based on operation performance and design purpose of the memory system 110, operation characteristics of the memory device 150 or the warranty or endurance of the memory system 110. For example, the criterion for the high-level error may be determined based on performance of the error correction circuitry 138 included in the controller 130. In addition, when the controller 130 supports chipkill decoding or erasure coding for error correction, the high-level error may be determined according to whether a corresponding operation is performed. In addition, according to an embodiment, the criterion for determining the high-level may be set during a test process of the memory system 110. Further, the controller 130 can dynamically (i.e., during run-time) set or determine the criterion based on lifespan or durability of the memory device 150. The determined criterion may be stored in the memory device 150.

FIG. 11 illustrates an example of an operation for refreshing non-volatile memory cells in a memory device. By the way of example but not limitation, a refresh operation can be performed when an error is corrected after reading a data chunk stored in an MLC block included in the memory device 150 (refer to FIGS. 1 to 3) is described.

Referring to FIG. 11, it is assumed that a non-volatile memory cell can store 2-bit data. The two-bit data can be classified into four types: “11,” “10,” “01,” and “00.” A threshold voltage distribution of non-volatile memory cells can be formed corresponding to each type. have. When plural read voltages REF1, REF2, REF3 are supplied to the non-volatile memory cells through the voltage supply circuit 70 described in FIG. 1, the 2-bit data stored in the non-volatile memory cells can be identified.

As a time passes after the data is stored in the non-volatile memory cell, the threshold voltage of the non-volatile memory cell may be shifted. That is, the threshold voltage distribution of the nonvolatile memory cell can shift or move to the left as the data retention time increases. Thus, when the read voltages REF1, REF2, REF3 are supplied to the non-volatile memory cells through the voltage supply circuit 70, a retention error may occur in some of the non-volatile memory cells.

In an embodiment of the disclosure, when the error level of the data chunk is not high (Not-High Level Error), the corrected data chunk may not be programmed to a new location (operation 432 in FIG. 9). However, when the controller 130 determines that an error has occurred due to a shift or a change of the threshold voltage distribution of the non-volatile memory cells according to the data retention time, the controller 130 can perform an operation for maintaining or improving data safety or data protection. In an embodiment, the controller 130 may perform an internal programming-based Flash Correct-and-Refresh (FCR) mechanism to improve the data safety.

For example, in order to reduce overhead generated from a re-mapping operation for generating and updating a map data segment when the data chunk is copied to a new location, the controller 130 can maintain the position of the data chunk but refresh non-volatile memory cells at the original location through an incremental step pulse program (ISPP) technique, to achieve a substantially similar effect as re-programming the corrected data. Because the ISPP technique can be performed based on the corrected data chunk with in-place reprogramming without changing the location of the data chunk, the overhead caused by the re-mapping operation could be reduced.

Typically, all values stored in non-volatile memory cells are erased in order to program data into non-volatile memory cells. Through this erase operation, charges captured in floating gates of the non-volatile memory cells can be removed, so that the threshold voltages thereof can be set to the initial value. When a non-volatile memory cell is programmed, a high positive voltage supplied to a control gate causes electrons to be captured in the floating gate, and a shifted threshold voltage of the non-volatile memory cell can be understood as data, i.e., a programmed value. Similarly, the ISPP technique can be used to inject an amount of charge, corresponding to the corrected data, into the floating gate. Through the ISPP technique, the floating gate can be gradually or repeatedly programmed, using a step-by-step program and verification operation. After each program step is performed, the threshold voltage of the non-volatile memory cell can be increased. Then, the increased threshold voltage of the non-volatile memory cell can be sensed and then compared with a target value (e.g., the corrected data). When the threshold voltage of the nonvolatile memory cell is higher than a level corresponding to the target value, the step-by-step program and verification operation may be stopped or halted. Otherwise, the non-volatile memory cell can be programmed once again so that more electrons may be captured in the floating gate to increase the threshold voltage. This step-by-step program and verification operation can be performed repeatedly until the threshold voltage of the non-volatile memory cell reach the level corresponding to the target value. The ISPP technique can be used to change an amount of charges captured in the non-volatile memory cell in a direction from a low to a high electron count (e.g., a right arrow in FIG. 11).

The threshold voltages of the non-volatile memory cells can be shifted in the direction of left arrow (the direction in which an amount of charges in the floating gate decreases) during the data retention time.

The controller 130 can perform the ISPP technique to shift the threshold voltage distribution of the non-volatile memory cells in a right direction, The controller 130 may refresh the non-volatile memory cells without an erasing operation through this ISPP technique based on the error-corrected data chunk, to improve the data safety.

In an embodiment, the memory system can improve safety or protection of data stored in a non-volatile memory device, as well as durability of the non-volatile memory device.

In another embodiment, the memory system can reduce overhead of operations performed for safety or protection of data stored in the non-volatile memory device to improve performance or input/output (I/O) throughput of the memory system.

While the present teachings have been illustrated and described with respect to specific embodiments, it will be apparent to those skilled in the art in light of the present disclosure that various changes and modifications may be made without departing from the spirit and scope of the invention as defined in the following claims.

What is claimed is:

1. A memory system, comprising:
a memory device including a first memory block and a second memory block, wherein the first memory block stores a first data chunk having a first size and the second memory block stores a second data chunk having a second size, and the first size is less than the second size; and
a controller operatively coupled to the memory device,
wherein the controller is configured to read the second data chunk from the second memory block, correct at least one error of the second data chunk when the at least one error is detected, and copy a portion of the second data chunk to the first memory block, and
wherein the portion of the second data chunk is error-corrected and has the first size.

2. The memory system according to claim 1,
wherein the memory device is further configured to store a first map data segment associated with the first data chunk and a second map data segment associated with the second data chunk, and
wherein the controller Is further configured to check an operational status of the second memory block to determine whether to read the second data chunk from the second memory block, and
wherein the controller is further configured to read the second data chunk from the second memory block based on the second map data segment.

3. The memory system according to claim 2, wherein the operational status of the second memory block is determined based on a retention time and a program/erase cycle (P/E cycle) of the second memory block.

4. The memory system according to claim 1, wherein a number of bits stored in a non-volatile memory cell in the first memory block is less than a number of bits stored in a non-volatile memory cell in the second memory block.

5. The memory system according to claim 1,
wherein the first memory block is used as a cache memory and the second memory block is used as a main storage, and
wherein the controller is further configured to perform a read operation on the first memory block first before accessing the second memory block.

6. The memory system according to claim 1, wherein the controller is further configured to determine an error level of the second data chunk based on at least one of an amount of errors detected within the second data chunk or a process for correcting the error detected in the second data chunk, and copy the error-corrected portion of the second data chunk to first memory block when the error level of the second data chunk is greater than or equal to a threshold.

7. The memory system according to claim 6, wherein the controller is configured to refresh the second memory block when the error level is less than the threshold.

8. The memory system according to claim 7, wherein the controller further configured to determine the threshold based on at least one of an operational status of the second memory block, an error correction capability of the controller and a performance of the memory system.

9. The memory system according to claim 1, wherein the controller is further configured to determine whether to read the second data chunk after entering an idle state.

10. The memory system according to claim 2, wherein the first map data segment is stored in the first memory block and the second map data segment is stored in the second memory block.

11. The memory system according to claim 2, wherein the first map data segment and the second map data segment are stored in a third memory block which is different from either of the first and second memory blocks.

12. A method for operating a memory system, comprising:
reading a second data chunk from a second memory block;
correcting at least one error of the second data chunk when the at least one error is detected; and
copying a portion of the second data chunk to a first memory block,
wherein the first memory block stores the first data chunk having a first size and the second memory block stores the second data chunk having a second size,
wherein the first size is less than the second size, and
wherein the portion of the second data chunk is error-corrected and has the first size.

13. The method according to claim 12, further comprising:
storing a first map data segment associated with the first data chunk and a second map data segment associated with the second data chunk; and
checking an operational status of the second memory block to determine whether to read the second data chunk stored in the second memory block,
wherein the second data chunk is read from the second memory block based on the second map data segment.

14. The method according to claim 13, wherein the operational status of the second memory block is determined based on a retention time and a program/erase cycle (P/E cycle) of the second memory block.

15. The method according to claim 12, wherein a number of bits stored in a non-volatile memory cell included in the first memory block is less than a number of bits stored in a non-volatile memory cell included in the second memory block.

16. The method according to claim 12, further comprising:
performing a read operation on the first memory block first before accessing the second memory block,
wherein the first memory block is used as a cache memory and the second memory block is used as a main storage.

17. The method according to claim 15, further comprising:
determining an error level of the second data chunk based on an amount of errors detected in the second data chunk or a process for correcting the error detected in the second data chunk,
wherein the copying of the portion of the second data chunk includes copying the error-corrected portion of the second data chunk to first memory block when the error level of the second data chunk is greater than or equal to a threshold.

18. The method according to claim 17, wherein the copying of the portion of the second data chunk further includes refreshing the second memory block when the error level is less than the threshold, and
the method further comprising determining the threshold based on at least one of an operational status of the second memory block, an error correction capability of the controller and a performance of the memory system.

19. The method according to claim 12, further comprising:
determining whether to read the second data chunk after entering an idle state;
storing the first map data segment in the first memory block and the second map data segment in the second memory block individually; and
storing the first map data segment and the second map data segment in a third memory block which is different from either of the first and second memory blocks.

20. A computer program product tangibly stored on a non-transitory computer readable medium, the computer program product comprising instructions to cause a multicore processor device that comprises a plurality of processor cores, each processor core comprising a processor and circuitry configured to couple the processor to a memory device including a first memory block storing a first data chunk having a first size and a second memory block storing a second data chunk having a second size, to:
read the second data chunk from the second memory block;
correct at least one error of the second data chunk when the at least one error is detected; and
copy a portion of the second data chunk to the first memory block,
wherein the portion of the second data chunk is error-corrected and has the first size, and
wherein the first size is less than the second size.
